(19) United States
(12) Patent Application Publication
(10) Pub. No.: US 2025/0368028 A1
(43) Pub. Date: Dec. 4, 2025

(54) ENGINE VIBRATION REDUCTION STRUCTURE

(71) Applicant: TOYOTA JIDOSHA KABUSHIKI KAISHA, Toyota-shi (JP)

(72) Inventor: Yoshihide NARITA, Toyota-shi (JP)

(73) Assignee: TOYOTA JIDOSHA KABUSHIKI KAISHA, toyota-shi (JP)

(21) Appl. No.: 19/016,536

(22) Filed: Jan. 10, 2025

(30) Foreign Application Priority Data
May 30, 2024 (JP) 2024-088067

(51) Int. Cl. B60K 6/40; B60K 6/26; H01M 10/615; H01M 10/625; H01M 10/655

(52) U.S. Cl. CPC B60K 6/40; B60K 6/26; H01M 10/615; H01M 10/625; H01M 10/655; H01M 2220/20

(57) ABSTRACT

A heat exchanger that is for raising a temperature of a battery of a plug-in hybrid electric vehicle is disposed away from a vehicle-upper side of an engine mount. Further, the first bracket is disposed on the front side in the vehicle front-rear direction with respect to the heat exchanger in the vehicle plan view to couple the heat exchanger and the engine mount, the second bracket is disposed on the rear side in the vehicle front-rear direction with respect to the heat exchanger in the vehicle plan view to couple the heat exchanger and the engine mount.

### CROSS-REFERENCE TO RELATED APPLICATION

This application claims priority to Japanese Patent Application No. 2024-088067 filed on May 30, 2024, incorporated herein by reference in its entirety.

### BACKGROUND

### 1. Technical Field

The present disclosure relates to an engine vibration reduction structure.

### 2. Description of Related Art

Japanese Unexamined Patent Application Publication No. 6-270699 (JP 6-270699 A) discloses technology related to a structure for reducing vibration of an engine mount member. Briefly, in this related art, a mass damper and a dynamic damper are attached to the engine mount member using the same fixture, so as to further reduce vibration or vibration noise that is transmitted to a vehicle body side.

### SUMMARY

However, in this related art, mass of the vehicle is increased by an amount corresponding to the mass of the mass damper and the dynamic damper that are attached.

In view of the above, it is an object of the present disclosure to provide an engine vibration reduction structure that is capable of reducing engine vibration and engine noise while suppressing increase in mass of a vehicle.

An engine vibration reduction structure according to a first aspect includes:
a heat exchanger that is for raising a temperature of a battery of plug-in hybrid electric vehicle, and that is disposed away from a vehicle-upper side of an engine mount,
a first bracket that is disposed on one side of the heat exchanger in vehicle plan view, and that links the heat exchanger and the engine mount, and
a second bracket that is disposed on another side that is opposite to the one side in vehicle plan view with respect to the heat exchanger, and that links the heat exchanger and the engine mount.

According to the engine vibration reduction structure of the first aspect, the heat exchanger that is for raising the temperature of the battery of plug-in hybrid electric vehicle is disposed away from the vehicle-upper side of the engine mount. Also, the first bracket is disposed on one side of the heat exchanger in vehicle plan view, and links the heat exchanger and the engine mount. The second bracket is disposed on the other side that is opposite to the one side in vehicle plan view with respect to the heat exchanger, and links the heat exchanger and the engine mount. This enables coupled resonance to be generated between the engine mount and the heat exchanger that is connected to the engine mount by the first bracket and the second bracket in a desired frequency band, thereby achieving a good vibration reduction effect. Also, the heat exchanger is installed for raising the temperature of the battery of plug-in hybrid electric vehicle. Accordingly, this is not separately installed to reduce engine vibration and engine noise, and thus increase in the mass of the vehicle can be suppressed.

According to an engine vibration reduction structure of a second aspect, in the engine vibration reduction structure of the first aspect, a rib is formed on an inner-face side of a housing of the heat exchanger.

According to the engine vibration reduction structure of the second aspect, the rib is provided on the inner-face side of the housing of the heat exchanger, and thus elastic deformation of wall faces of the housing of the heat exchanger when vibrating is suppressed. Thus, the natural frequency of the heat exchanger can be easily set to a frequency band that contributes to reducing engine vibration.

As described above, the engine vibration reduction structure according to the present disclosure exhibits excellent advantages in that engine vibration and engine noise can be reduced while suppressing increase in the mass of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an engine vibration reduction structure according to an embodiment of the present disclosure when viewed from a vehicle right obliquely front side;

FIG. 2 is a perspective view illustrating an engine vibration reduction structure according to an embodiment of the present disclosure when viewed from a left obliquely rear side of a vehicle;

FIG. 3 is a diagram schematically illustrating a vehicle to which the engine vibration reduction structure of FIG. 1 is applied;

FIG. 4 is a graph illustrating vibration characteristics of an engine vibration reduction structure and a comparison structure according to an embodiment;

FIG. 5 is a perspective view showing the first contrast arrangement as viewed from the vehicle-right diagonally front side; and

FIG. 6 is a perspective view illustrating the second comparison structure as viewed from the vehicle right obliquely front side.

### DETAILED DESCRIPTION OF EMBODIMENTS

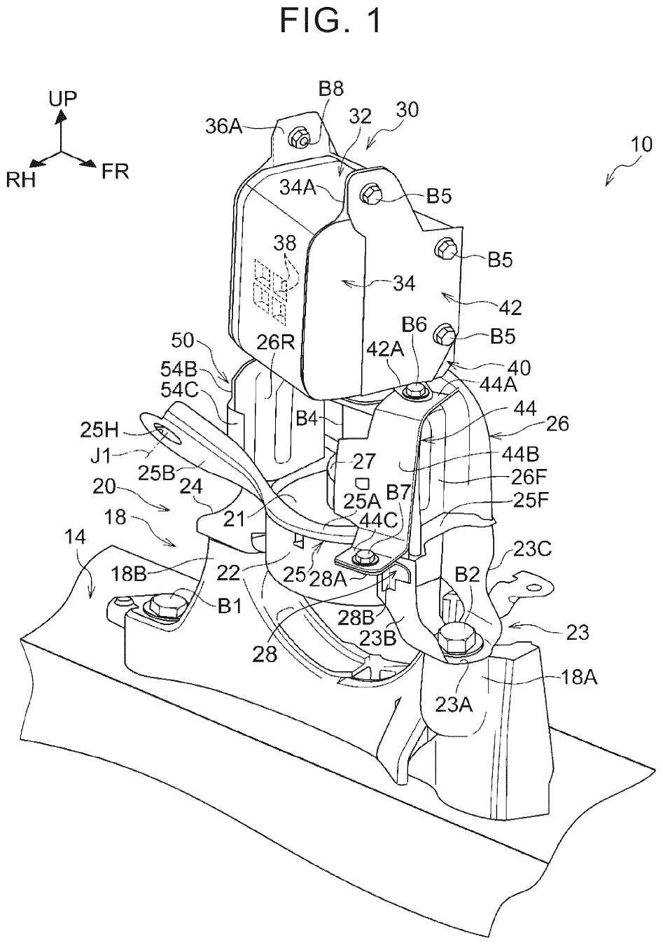

An engine vibration reduction structure according to an embodiment of the present disclosure will be described with reference to FIGS. 1 to 6. Arrow FR shown as appropriate in FIGS. 1 to 3, 5 and 6 indicate the vehicle front side, arrow UP indicates the vehicle upper side, and arrow RH indicates the vehicle right side.

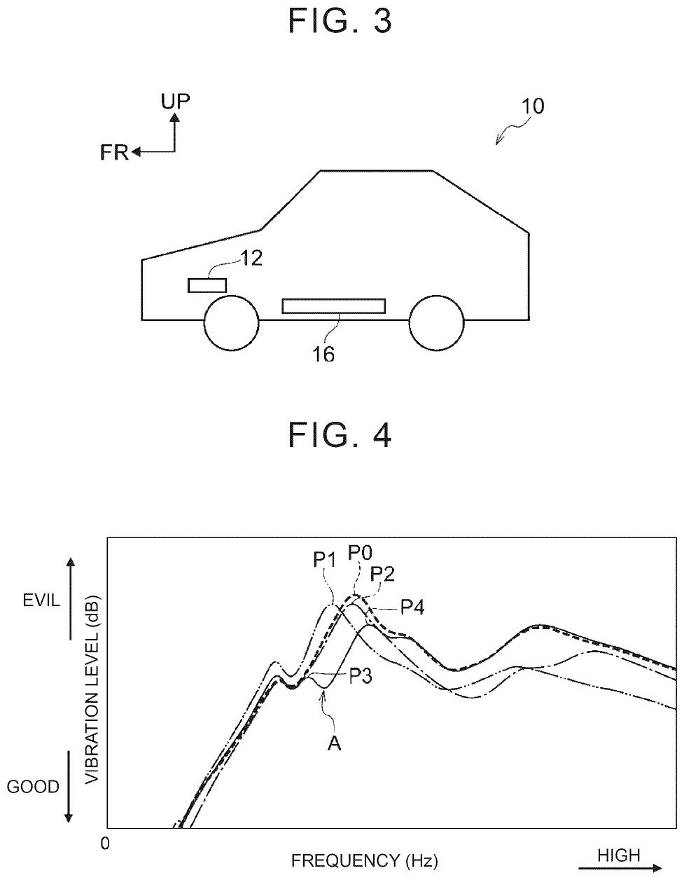

FIG. 3 schematically illustrates a vehicle 10 to which the engine vibration reduction structure according to the present embodiment is applied. The vehicles 10 are plug-in hybrid electric vehicle (PHEV (Plug-in Hybrid Electric Vehicle)). The vehicle 10 includes an engine 12 at a front portion of the vehicle. Note that the fastening of the engine 12 to the vehicle body side is performed at, for example, a plurality of places via an engine mount except for the parts described below, and the description of the fastening of these places is omitted.

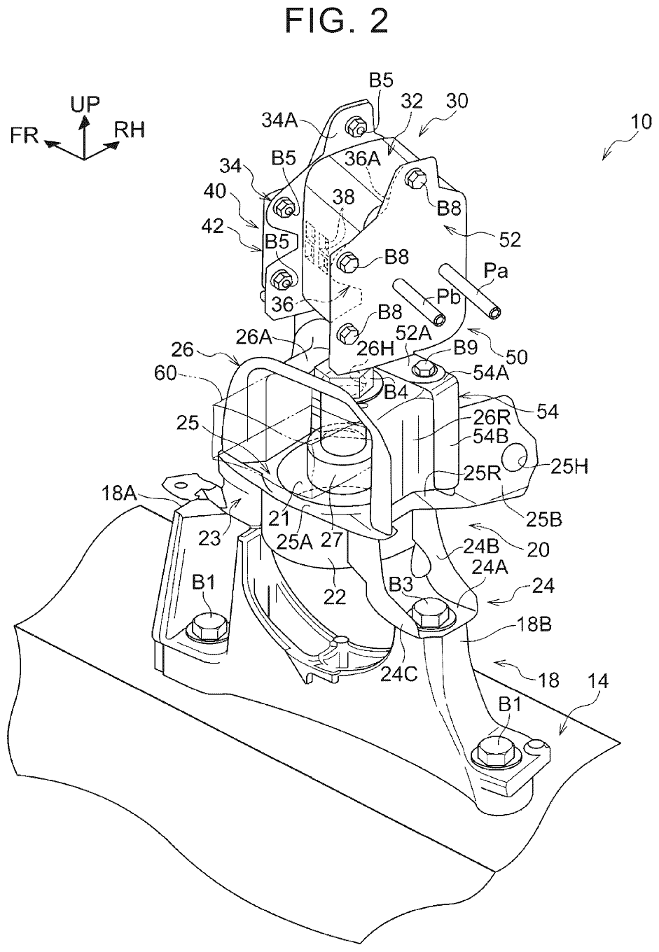

FIG. 1 is a perspective view of an engine vibration reduction structure provided in a vehicle 10 viewed from a vehicle right obliquely front side, and FIG. 2 is a perspective view of an engine vibration reduction structure provided in the vehicle 10 viewed from a vehicle left obliquely rear side. The components shown in FIGS. 1 and 2 are components for fastening the right side of the engine 12 (see FIG. 3) to the vehicle body side.

As shown in FIGS. 1 and 2, the engine mount 20 is mounted to a front side member 14 (shown in simplified form in the drawings) via an engine mount bracket 18. The front side member 14 is a vehicle skeleton member that extends along the vehicle front-rear direction at a side portion of the vehicle front portion. The engine mount bracket 18 is fixed to the upper surface of the front side member 14 by fastening using a bolt B1. The front part of the engine mount bracket 18 is formed with a front side base portion 18A formed in a convex shape on the vehicle upper side, and the rear part of the engine mount bracket 18 is formed with a rear side base portion 18B formed in a convex shape on the vehicle upper side.

The engine mount 20 includes a cylinder portion 22 formed in a cylindrical shape and having a rubber member 21 attached to the inside thereof, a front side leg portion 23 welded to the front side of the cylinder portion 22, and a rear side leg portion 24 welded to the rear side of the cylinder portion 22. The engine mount 20 further includes an armed annular member 25 welded to the upper end opening portion of the cylinder portion 22 shown in FIG. 2 without closing the opening portion, and an inverted U-shaped curved plate portion 26 welded to the upper surface of the base end portion 25A of the armed annular member 25. Further, in the engine mount 20, a nut 27 (illustrated in a simplified manner in the drawing) is fixed to the rubber member 21 attached to the inside of the cylinder portion 22, and the nut 27 protrudes upward of the rubber member 21.

As shown in FIG. 1, the front side leg portion 23 is bent in a substantially U-shape so that the front side or the vehicle upper side of the engine mount bracket 18 is opened while being extended from a part adjoining the cylinder portion 22 on the front side toward the front side base portion 18A. The front side leg portion 23 includes a fixed portion 23A that is superposed on the upper surface side of the front side base portion 18A of the engine mount bracket 18, and side portions 23B, 23C that are formed on both sides in the widthwise direction (right-left direction). The fixed portions 23A of the front side leg portion 23 are fastened to the front side base portion 18A of the engine mount brackets 18 by bolt B2. An attaching member 28 is welded to a surface facing the right side of the vehicle at an upper portion of the right side portion 23B in the right-left direction of the vehicle. The attaching member 28 includes an attaching portion 28A bent and extended to the right side of the vehicle at an upper end portion thereof, and a rib 28B is formed to increase the rigidity of the bending portion. The attachment partner of the attaching member 28 will be described later.

As shown in FIG. 2, the rear side leg portion 24 is bent in a substantially U-shape so as to extend from a portion adjoining the rear side with respect to the cylinder portion 22 toward the rear side base portion 18B side of the engine mount bracket 18 and to open the vehicle rear side or the vehicle upper side. The rear side leg portion 24 includes a fixed portion 24A that is superposed on the upper surface side of the rear side base portion 18B of the engine mount bracket 18, and side portions 24B, 24C that are formed on both sides in the widthwise direction (right-left direction). The fixed portion 24A of the rear side leg portion 24 is fastened to the rear side base portion 18B of the engine mount bracket 18 by bolt B3.

As shown in FIG. 1, the base end portion 25A of the armed annular member 25 is formed in an annular shape along the upper end opening portion of the cylinder portion 22. A lower end portion of the front wall portion 26F of the curved plate portion 26 is welded to a part of the front portion 25F of the armed annular member 25 in the front-rear direction of the vehicle. Further, as shown in FIG. 2, the lower end portion of the rear wall portion 26R of the curved plate portion 26 is welded to a part of the rear portion 25R of the armed annular member 25 in the front-rear direction.

As shown in FIG. 1, the armed annular member 25 has an arm portion 25B extending from the base end portion 25A side to the vehicle-right diagonally upward side. A bolt-fastening hole 25H is formed at a distal end portion of the arm portion 25B in the extending direction. A distal end portion of the arm portion 25B in the extending direction is fastened to an apron (not shown) constituting a part of the vehicle body by using a bolt (not shown, a center axial line of the bolt is indicated by a dashed-dotted line J1) that penetrates the bolt fastening hole 25H.

As shown in FIG. 2, the curved plate portion 26 provided on the upper side of the armed annular member 25 is formed in an inverted U shape when viewed in the vehicle width direction. A bolt insertion hole 26H is formed through the upper wall portion 26A of the curved plate portion 26. Engine brackets 60 are arranged on the lower side of the upper wall portion 26A of the curved plate portion 26 and on the upper side of the nut 27. The engine bracket 60 is a member that is fixed to an engine (not shown) and protrudes toward the engine mount 20. In FIG. 2, only a part of the outer shape of the engine bracket 60 is simplified and indicated by a two-dot chain line. In FIG. 1, the engine bracket 60 is not illustrated. As shown in FIG. 2, the bolt B4 is inserted from above into the bolt insertion hole 26H formed in the upper wall portion 26A of the curved plate portion 26. The bolt B4 passes through the upper wall portion 26A of the curved plate portion 26 and the engine bracket 60 and is screwed into the nut 27.

On the other hand, the heat exchanger 30 is disposed at a distance from the vehicle upper side of the engine mount 20. The heat exchanger 30 serves to raise the temperature of the battery 16 (see FIG. 3) of the vehicle 10, which is a plug-in hybrid electric vehicle, and contributes to improving the rapid charge performance of the battery 16 in a low-temperature environment. In supplementation, the heat exchanger 30 is a water-water heat exchanger associated with an air conditioning system, and is mounted on vehicles 10 that are plug-in hybrid electric vehicle. In the heat exchanger 30, two pipe Pa, Pb are connected to a rear-side part in the front-rear direction, and water can enter and exit the heat exchanger 30 by the two pipe Pa, Pb.

The heat exchanger 30 includes a substantially box-shaped housing 32. A rib 38 is formed on the inner surface side of the housing 32 of the heat exchanger 30. The rib 38 is formed in a lattice shape as an example. The formation range of the rib 38 can be set as appropriate, but in the present embodiment, the rib is formed over the entire arca on the inner surface side of the housing 32 as an example.

Further, the heat exchanger 30 includes a front panel 34 that constitutes a front surface in the vehicle front-rear direction as shown in FIG. 1, and a rear panel 36 that constitutes a rear surface in the vehicle front-rear direction as shown in FIG. 2. As shown in FIG. 1, the front panel 34 includes an upper protruding piece portion 34A protruding upward. As shown in FIG. 2, the rear panel 36 includes an upper protruding piece portion 36A protruding upward.

In addition, a first bracket 40 that connects the heat exchanger 30 and the engine mount 20 is disposed on the front side in the vehicle front-rear direction (one side in the vehicle plan view) in the vehicle plan view with respect to the heat exchanger 30 shown in FIG. 1. As an example, the first bracket 40 is configured such that an upper component member 42 constituting the upper side and a lower component member 44 constituting the lower side are connected to each other. Each of the upper component member 42 and the lower component member 44 is a bent plate-like member made of metal (for example, steel).

The upper component 42 of the first bracket 40 is superposed on the front panel 34 at a part including the upper protruding piece portion 34A, and is fastened to the upper protruding piece portion 34A of the front panel 34 and the upper and lower parts of the left and right end parts of the vehicle by a bolt B5. The lower end position of the upper component member 42 is the same as the lower end position of the front panel 34 in the vertical direction. In addition, the upper component member 42 includes a protruding portion 42A that is bent and protrudes from a lower end portion thereof toward the front side of the vehicle. In the first brackets 40, the protruding portions 42A of the upper component members 42 are superposed on the upper end portions 44A of the lower component members 44, and are fastened by bolting B6.

The lower component member 44 is bent and suspended from an end portion of the upper end portion 44A on the right side in the vehicle right-left direction, and the hanging portion 44B is arranged such that the plate thickness direction thereof is along the vehicle width direction. Further, the lower component member 44 includes an extending portion 44C that is bent from the lower end portion of the hanging portion 44B to the right side in the right-left direction of the vehicle. The extending portion 44C is superposed on the attaching portion 28A of the attaching member 28 and fastened by a bolt B7. In the first bracket 40, a position at which the extending portion 44C of the lower component member 44 is fastened to the attaching member 28 of the engine mount 20 by bolting B7 is defined as a first fastening position. The first fastening position is a position closer to the front side of the vehicle than the second fastening position, which is a position where the upper component member 42 is fastened to the heat exchanger 30 by a bolt B5.

In addition, a second bracket 50 that connects the heat exchanger 30 and the engine mount 20 is disposed on the rear side in the vehicle front-rear direction (the other side opposite to the one side in the vehicle plan view) with respect to the heat exchanger 30 shown in FIG. 2 in the vehicle plan view. As an example, the second bracket 50 is configured such that the upper component member 52 constituting the upper side and the lower component member 54 constituting the lower side are connected to each other. Each of the upper component member 52 and the lower component member 54 is a bent plate-like member made of metal (for example, steel).

The upper component member 52 of the second bracket 50 is superposed on the rear panel 36 at a part including the upper protruding piece portion 36A, and is fastened to the upper protruding piece part portion 36A of the rear panel 36 and the upper and lower parts of the left and right end parts of the vehicle by bolting B8. The lower end position of the upper component member 52 is the same as the lower end position of the rear panel 36 in the vertical direction. Further, the upper component member 52 includes a protruding portion 52A that is bent toward the rear side of the vehicle from the lower end portion thereof and protrudes. In the second brackets 50, the protruding portions 52A of the upper component members 52 are superposed on the upper end portions 54A of the lower component members 54, and are fastened by bolting B9.

The lower component member 54 is bent and suspended from an end portion of the upper end portion 54A on the rear side in the vehicle front-rear direction, and the hanging portion 54B is arranged such that the plate thickness direction thereof extends along the vehicle front-rear direction. Further, as shown in FIG. 1, a portion of the right side in the vehicle right-left direction of the hanging portion 54B is a return portion 54C folded back to sandwich the rear wall portion 26R of the curved plate portion 26, and the return portion 54C is welded to the rear wall portion 26R of the curved plate portion 26. In the second brackets 50, a position where the return portion 54C of the lower component member 54 is joined to the curved plate portion 26 of the engine mount 20 is defined as a joining position. The joining position is a position closer to the rear of the vehicle than the position where the upper component member 52 shown in FIG. 2 is fastened to the heat exchanger 30 by bolting B8.

As described above, the first bracket 40, the second bracket 50, and the heat exchanger 30 generate a moment that is large to some extent when the engine mount 20 is in the tilt mode in the right-left direction.

Next, operations and effects of the present embodiment will be described.

In the present embodiment, the heat exchanger 30 used to raise the temperature of the battery 16 (see FIG. 3) of the vehicle 10, which is a plug-in hybrid electric vehicle, is disposed to be spaced apart from the vehicle upper side of the engine mount 20. Further, the first bracket 40 shown in FIG. 1 is disposed on the front side in the vehicle front-rear direction (one side in the vehicle plan view) with respect to the heat exchanger 30 in the vehicle plan view to connect the heat exchanger 30 and the engine mount 20. The second bracket 50 shown in FIG. 2 is disposed on the rear side in the vehicle front-rear direction (the other side opposite to the one side in the vehicle plan view) with respect to the heat exchanger 30 in the vehicle plan view, and connects the heat exchanger 30 and the engine mount 20. Thus, the coupled resonance between the engine mount 20 and the heat exchanger 30 connected to the engine mount 20 by the first bracket 40 and the second bracket 50 is generated in a desired frequency band. This makes it possible to obtain a good vibration reduction effect (to obtain a desired dynamic damper effect). The heat exchanger 30 is mounted for raising the temperature of the battery 16 (see FIG. 3) of the vehicle 10, which is a plug-in hybrid electric vehicle. Therefore, since the vehicle 10 is not separately mounted in order to reduce engine vibration and engine noise, it is possible to suppress an increase in mass of the vehicle.

Further, in the present embodiment, since the rib 38 is formed on the inner surface side of the housing 32 of the heat exchanger 30, the elastic deformation of the wall surface of the housing 32 of the heat exchanger 30 during vibration is suppressed. Thus, the natural frequency of the heat exchanger 30 can be easily set to a frequency band that contributes to reducing the engine vibration.

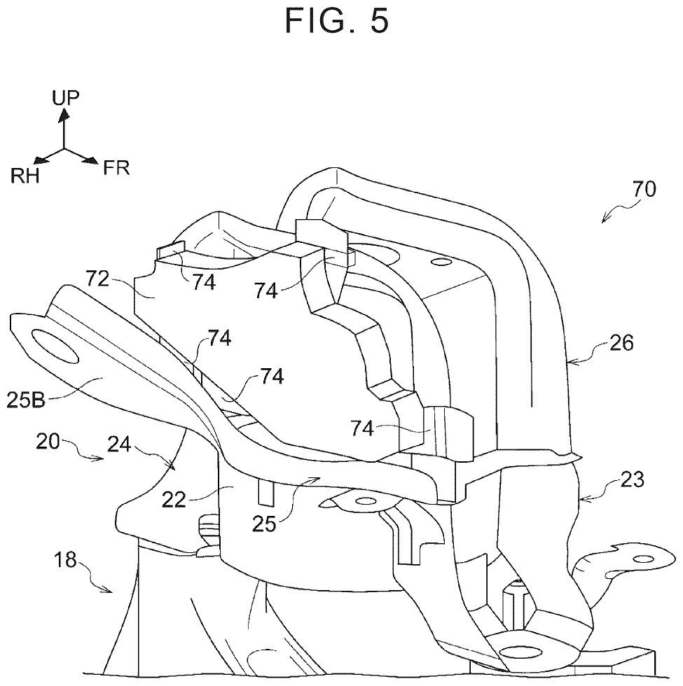

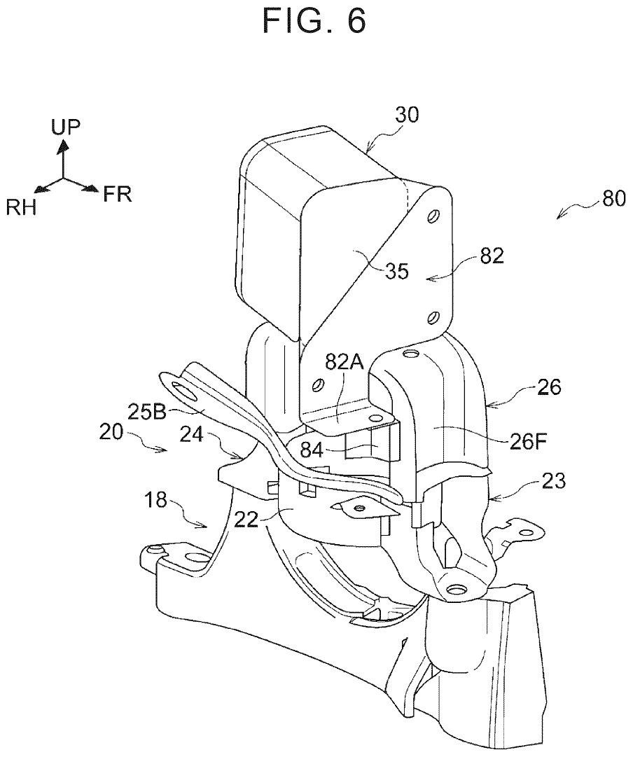

Here, the effects of the present embodiment will be described in comparison with the first comparison structure 70 shown in FIG. 5 and the second comparison structure 80 shown in FIG. 6. In the first comparison structure 70 illustrated in FIG. 5 and the second comparison structure 80 illustrated in FIG. 6, components substantially the same as those in the present embodiment are denoted by the same reference numerals for convenience.

The first comparison structure 70 shown in FIG. 5 is a structure in which a weight (mass damper) 72 is fixed to the engine mount 20 in place of the first bracket 40, the second bracket 50, and the heat exchanger 30 (see FIGS. 1 and 2) of the present embodiment. A plurality of attachment members 74 are fixed to the weight 72, and the plurality of attachment members 74 are fixed to the curved plate portions 26, respectively. In FIG. 5, the bolt B2, B4 and the nut 27 illustrated in FIG. 2 are omitted for convenience.

The second comparison structure 80 shown in FIG. 6 has a configuration including the front side bracket 82 instead of the first bracket 40 (see FIG. 1) of the present embodiment, and not including the second bracket 50 (see FIG. 2) of the present embodiment. The front side brackets 82 are formed in a bent plate shape made of steel, and are fastened to a plurality of portions of the left end portion and the lower portion of the front panel 35 of the heat exchanger 30 by bolts (not shown), and are provided with an extending portion 82A bent toward the front of the vehicle at the lower end portion. The extending portion 82A is fastened by bolts (not shown) to a steel attachment member 84 welded to a right-side portion of the front wall portion 26F of the curved plate portion 26 in the vehicle-right-left direction. In FIG. 6, the bolt B1, B2, B4, the rubber member 21, and the nut 27 illustrated in at least one of FIGS. 1 and 2 are omitted for convenience.

FIG. 4 is a graph illustrating a relationship between a frequency of vibration at the time of right-left excitation and a vibration level (excitation point inertance) in the engine vibration reduction structure and the comparison structure according to the embodiment. The dotted line in the graph of FIG. 4 indicates the characteristics of the comparison structure before countermeasures in which the first bracket 40, the second bracket 50, and the heat exchanger 30 (see FIGS. 1 and 2) are removed from the engine vibration reduction structure of the present embodiment. In the graph of FIG. 4, the two-dot chain line indicates the characteristics of the first comparison structure 70 (see FIG. 5), the one-dot chain line indicates the characteristics of the second comparison structure 80 (sec FIG. 6), and the solid line indicates the characteristics of the engine vibration reduction structure according to the present embodiment.

As shown in FIG. 4, in the case of the first comparison structure 70 (see the two-dot chain line), the position of the peak Pl of the oscillation level is slightly left-shifted and slightly lower in the graph than the position of the peak P0 in the case of the comparison structure prior to the countermeasure (see the dotted line). However, only an effect as a mass damper has been obtained. In the second comparison structure 80 (see the dashed-dotted line), the peak P2 of the vibration level is slightly lower, but the rigidity of the coupling part between the engine mount 20 and the heat exchanger 30 is lower, so that the dynamic damper is less effective.

On the other hand, in the engine vibration reduction structure according to the present embodiment (see the solid line), a coupled resonant P3, P4 is generated between the engine mount 20 and the heat exchanger 30 connected to the engine mount 20 by the first bracket 40 and the second bracket 50. This coupled resonant P3, P4 occurs at frequencies that are slightly lower and slightly higher than the frequency at the peak P0 for the previous contrasting configuration (see dotted line). The vibration level of the coupled resonant P3, P4 is lower than the vibration level of the peak P0. Further, an anti-resonance (refer to a part indicated by an arrow A) is generated between the two coupled resonant P3, P4, so that the vibration level is effectively lowered in a frequency band in which the vibration level is desired to be lowered.

As described above, according to the engine vibration reduction structure of the present embodiment shown in FIGS. 1 and 2, it is possible to reduce the engine vibration and the engine noise while suppressing an increase in the mass of the vehicle.

As a modification of the above-described embodiment, for example, in a structure including an engine mount provided on the rear side in the vehicle front-rear direction with respect to the engine 12, the heat exchanger 30 may be disposed to be spaced apart from the engine mount on the vehicle upper side. The first bracket may be disposed on the left side in the vehicle right-left direction (one side in the vehicle plan view) with respect to the heat exchanger 30 in the vehicle plan view to connect the heat exchanger 30 and the engine mount. The second bracket may be disposed on the right side in the vehicle right-left direction (the other side opposite to the one side in the vehicle plan view) with respect to the heat exchanger 30 in the vehicle plan view to connect the heat exchanger 30 and the engine mount.

Further, in the above embodiment, the first bracket 40 is such that the upper component member 42 and the lower component member 44 are connected to each other, but as a modification of the above embodiment, the first bracket may be formed of a partial material. Further, in the above-described embodiment, the second bracket 50 is such that the upper component member 52 and the lower component member 54 are connected to each other, but as a modification of the above-described embodiment, the second bracket may be formed of a partial material.

Further, in the above embodiment, the rib 38 is formed on the inner surface side of the housing 32 of the heat exchanger 30, such a configuration is preferable. However, as a modification of the above-described embodiment, a configuration may be adopted in which the rib is not formed on the inner surface side of the casing of the heat exchanger depending on the material of the casing of the heat exchanger or the like.

The above-mentioned embodiments and the above-mentioned modified examples can be appropriately combined and implemented.

Although an example of the present disclosure has been described above, it goes without saying that the present disclosure is not limited to the above example, and various modifications other than the above can be carried out without departing from the spirit of the present disclosure.

What is claimed is:

1. An engine vibration reduction structure, comprising:
a heat exchanger that is for raising a temperature of a battery of plug-in hybrid electric vehicle, and that is disposed away from a vehicle-upper side of an engine mount;
a first bracket that is disposed on one side of the heat exchanger in a vehicle plan view, and that links the heat exchanger and the engine mount; and
a second bracket that is disposed on another side that is opposite to the one side in the vehicle plan view with respect to the heat exchanger, and that links the heat exchanger and the engine mount.

2. The engine vibration reduction structure according to claim 1, wherein a rib is provided on an inner-face side of a housing of the heat exchanger.
